(19) United States
(12) Patent Application Publication
(10) Pub. No.: US 2008/0232658 A1
(43) Pub. Date: Sep. 25, 2008

(54) Interactive Multiple Gene Expression Map System

(76) Inventors: Kiminobu Sugaya, Winter Park, FL (US); Balaji Gandhi, Orlando, FL (US); Srikanth Yellanki, Normal, IL (US)

Correspondence Address: Beusse Wolter Sanks Mora & Maire, 390 N. ORANGE AVENUE, SUITE 2500, ORLANDO, FL, 32801, US

(21) Appl. No.: 11/813,679

(22) PCT Filed: Jan. 11, 2006
(86) PCT No.: PCT/US2006/000983

§ 371 Date: Jun. 2, 2008

Related U.S. Application Data
(60) Provisional application No. 60/642,925, filed on Jan. 11, 2005.

(51) Int. Cl. G06K 9/00

(52) U.S. Cl. 382/128

(57) ABSTRACT

Disclosed herein is a system and method for providing remotely accessible gene expression image data. The system and method allows for increased accuracy and semi-quantitative or fully quantitative data from images by enabling the remote user to select regions of interest on a compressed image, and then conducting quantitative analysis on original images at a central location. The subject invention relates to, in one embodiment, an BVIGEM (Interactive Multiple Gene Expression Maps) system: which provides internet based software tools for the extraction of functional information from gene expression images and also to act as a repository for gene expression image data.

This application claims benefit of the Jan. 11, 2005, filing date of U.S. provisional patent application No. 60/642,925.

### BACKGROUND

Bioinformatics has played a critical role in fueling the revolution in genomics that has occurred over the past decade. It is inconceivable to think how that field would have progressed without the infrastructure to store, analyze and search through the massive quantity of genomic mapping and sequencing data produced. Unlike the one dimensional text data that is at the heart of genomic information, the gene expression maps produced by histological data are two and/or three dimensional datasets. The existing digital atlases have very limited functional and graphical capabilities. The subject invention relates to, in one embodiment, an IMGEM (Interactive Multiple Gene Expression Maps) system: which provides internet based software tools for the extraction of functional information from gene expression images and also to act as a repository for gene expression image data.

The brain is a complex organ storing a great deal of information with a variety of cell types and different structures. To understand functions of the brain, researchers need better relational databases related to the brains structure and cell types. IMGEM is, to the inventors knowledge, the first construction of a 3D graphical interface database for that purpose.

Furthermore, reconstruction of 3D data set from 2D images would be especially useful in gene expression mapping of the brain. The subject invention provides 3D reconstruction of in-situ hybridization histochemistry (ISHH) thereby achieving several benefits. First, it enables generation of an exact coronal, sagittal and horizontal image from tilted experimental image data and comparison with a brain atlas. Second, it enables generation of an image that has several nuclei which can be used as the subject of comparison. Third, it enables investigation of gene expression along the projection of neurons.

In addition, volume of interest (VOI) analysis enables a measurement of the total amount of expressed gene in the brain. Since ISHH process requires extensive washing steps after heating of the section, size and shape of the sections can be altered. Techniques for minimizing these phenomena are desired. The combination of genomic and proteomic information of the brain structure at the cellular level, which is directly accessible from IMGEM will help in gaining insights to better understand the brain function.

### SUMMARY OF THE INVENTION

The inventors have employed technological advantages of electronic databases in the open source software sector by creating a series of brain atlases implemented via databases implemented through computer hardware and software to provide an interactive system referred to herein as the IMGEM system. The IMGEM system comprises several advantageous aspects: 1) IMGEM system contains archive 2D images of brain sections with multiple levels of resolution, and can share information with other researchers 2) by the 2D and 3D image analysis, IMGEM system facilitates the comparison of multiple gene expressions and morphological structures, 3) by 3D reconstruction of the image data, the IMGEM system will allow for free rotation of the 3D image and virtual-sectioning of the brain will be possible in any desired plane, 4) the IMGEM system includes a discussion board (or discussion forum) capability, which is capable of receiving responses or input from IMGEM users in real-time; and as an additional benefit, the IMGEM system can be readily edited and updated to reflect the real-time input of online users, 5) the IMGEM system may also be seamlessly integrated with other currently available online databases and hyperlinks to other data resources on the Internet will be highlighted on the images and easily accessible via the IMGEM system's user-friendly design and navigation.

The IMGEM system is a fully interactive, integrated and compatible to any platform. Most of the digital atlases currently available are build for either windows or mac platform, since the IMGEM system is developed as a strictly web based application which is developed in JAVA and other cross platform scripts making it truly platform independent. The IMGEM system is not a just another 3D brain atlas on the Internet, nor is it just another database because the IMGEM system also supports users to upload or provide links to their ISHH image data or any other kinds of gene expression image data to our servers directly from the website. The annotation feature of the IMGEM system will enable researchers to make non-destructive comments or notes on the images which will enable collaborating researchers to directly access the other researcher's notes on the image without downloading and image data. The IMGEM system allows for quantitative image processing which is enabled by the thin client 3D application by doing all the image processing on the quantitative TIFF image in the server, thereby overcoming the hurdles posed by the limitations of internet data transfer protocols. The IMGEM system will enable the scientific community to gain further insights from the information available (data in the present and future) for brain gene expression mapping; and in doing so, to seek to better apply this collective knowledge for our continued understanding of normal and diseased human brain function.

Construction a digital brain atlas has been tried before, but such conventional digital brain atlases are only able to show brain slices from archived JPEG images, or screen shots or a quick time movie of 3D reconstructed dataset. These do not accomplish real time manipulation of 3D data set in the browser. Due to the limitations of Internet traffic speed and scripting in Internet language, for example JAVA, the results are far behind from the commercial packages available in CD format which can installed. Furthermore the nature of the JPEG or GIF image file format used in the web browser diminishes a possibility of quantitative analysis of the image data. IMGEM addresses these problems, which always exist with distribution of experimental data through the Internet by advanced scripting and analysis of data set on the server with manipulation of the image on the client. The subject invention also aims to improve ISHH experimental procedure itself, since currently available protocol introduces artifacts (uneven message and distortion of the brain sections), which introduce complexity to the registration of 2D image for 3D reconstruction.

It is to be understood that the foregoing general description and the following detailed description are exemplary and explanatory only and are not to be viewed as being restrictive of the present, as claimed. These and other objects, features and advantages of the present invention will become apparent after a review of the following detailed description of the disclosed embodiments and the appended claims.

### BRIEF DESCRIPTION OF THE DRAWINGS

FIG. 1 is a graph depicting changes in the number of publications using gene expression and in situ hybridization.

FIG. 2 shows serial coronal sections of c-NOS mRNA ISHH. The images are enhanced by pseudo-color based on the optical density of film auto radiographs of the brain sections. Reddish color represents higher gene expression and cooler colors represent lower gene expression.

FIG. 3a shows a sample sagittal slice of iNOS mRNA ISHH. The original scanned TIFF image is 2508×1812 pixels and 8.9 MB in size.

FIG. 3b Differential pixel images, detected by the image subtraction, between original and after compression using JPEG (A: low compression, B: high compression), while TIFF or PNG did not show difference in this type of image.

FIG. 4 represents a screen shot of a dynamic real time 2D image viewer according to one embodiment of the subject invention. The panel on the top shows a full slide, and the panel in the bottom is the result of zooming in on a region of interest at the highest resolution possible as shown by the small triangle position on the toolbar.

FIG. 5 represents a screen shot of a dynamic real time 2D image viewer according to an embodiment of the subject invention. The viewer allows user to print the image and also make non-destructive user specific annotations which will enable them to save their regions of interest or other notes.

FIG. 6 represents serial 2D image of ISHH for APP gene expression in the rat brain.

FIG. 7 represents an example of the reconstruction of 3D data set from 2D ISHH data.

FIG. 8 is a screen shot of a 3D interactive viewer according to one embodiment of the invention. The 3D image stack is made of serial 2D images shown in FIG. 6. This viewer embodiment allows user to preview and rotate the 3D image and to select the slice of interest and open it in the image processing application.

FIG. 9 IMGEM image processing application which runs as an applet eliminating any software install on client machine. Using 3D IMGEM viewer the user can rotate the 3D image in the preview mode and after selecting the slice of interest, open the image in image processing application. The insets are the histogram and pseudo coloring of the selected region.

FIG. 10 shows the viewing and manipulation of a low resolution image on a client machine and request for high resolution image from a server.

FIG. 11 shows the retrieval of a high resolution image from a stack stored on a server.

FIG. 12 shows a method embodiment of storing and retrieving 2D data on a server.

### DETAILED DESCRIPTION

In reviewing the detailed disclosure which follows, and the specification more generally, it should be borne in mind that all patents, patent applications, patent publications, technical publications, scientific publications, websites, and other references referenced herein are hereby incorporated by reference in this application in order to more fully describe the state of the art to which the present invention pertains.

In one embodiment, the subject invention is directed to a system for providing remotely accessible gene expression image data. The system allows for increased accuracy and semi-quantitative or fully quantitative data from images by enabling the remote user to select regions of interest on a compressed image. Quantitative analysis of the selected region is conducted on original images at a central database location on the IMGEM servers and then the analysis results are conveyed to the remote user. The subject invention relates to, in one embodiment, an IMGEM (Interactive Multiple Gene Expression Maps) system: which provides internet based software tools for the extraction of functional information from gene expression images and also to act as a repository for gene expression image data.

Those skilled in the art should appreciate that the present invention may be implemented over a network environment. That is, the remote user may be a client on a number of conventional network systems, including a local area network (“LAN”), a wide area network (“WAN”), or the Internet, as is known in the art (e.g., using Ethernet, IBM Token Ring, or the like). Typically, the remote user accesses the system via the internet. As will be discussed below, embodiments of the subject invention will allow, for the first time, quantitative analyses and 3D manipulations directed by remote users via small bandwidth connection means, such as the internet.

As used herein, the term “processor” may include a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The processing module may have operationally coupled thereto, or integrated therewith, a memory device. The memory device may be a single memory device or a plurality of memory devices. Such a memory device may be a read-only memory, random access memory, volatile memory, non-volatile memory, static memory, dynamic memory, flash memory, and/or any device that stores digital information.

### EXAMPLE 1

### In-situ Hybridization Histochemistry

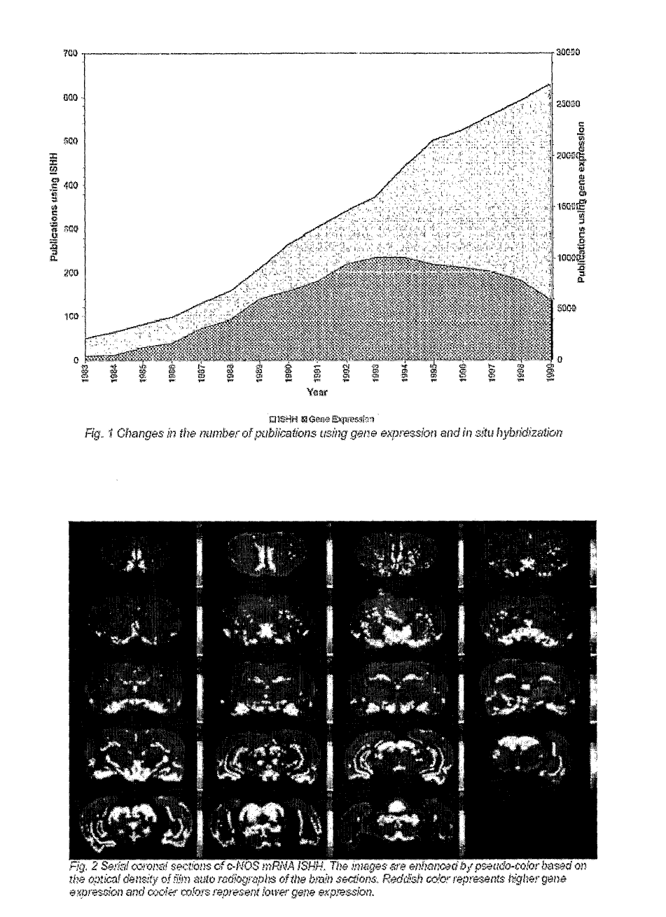

The demands for measurement of gene expression and publications using RT-PCR have been increasing dramatically (FIG. 1). The in-situ technique of gene hybridizationhistochemistry (ISHH) was introduced in 1983 and exponentially increased up to 1992, but after that the number of publication using ISHH has decreased. This may be because ISHH is a time and labor consuming experiment and difficult to perform in a quantitative way.

Since the brain is heterogeneous tissue and populations of brain cells are variable in each area of the brain, gene expression analysis using brain homogenate, such as RTPCR or gene array, may not be an accurate or effective way to investigate gene expression in the brain. For example, if we detect increases of certain gene expression in homogenate preparation, there are several possibilities occurring. The number of particular types of cells expressing the gene may be increased, gene expression in the same number of the cell groups may be increased or gene expression may be induced in other types of cells. On the other hand, even if we do not see a difference in gene expression levels using RT-PCR, the expression area could be expanded and total amount of gene expression may be increased. Although, current applications of micro dissection systems allow us to pinpoint particular populations of cells from a given brain slice, there is a possibility for significant loss of the signal and/or contamination, which dramatically decrease the quantitative information. Micro-dissection methods are typically labor intensive, usually requiring accumulation of as much as 500-2000 cells for analysis of one gene. Furthermore, as described above, in many cases gene expression per cell may not be changed, while total amount of gene expression could be changed.

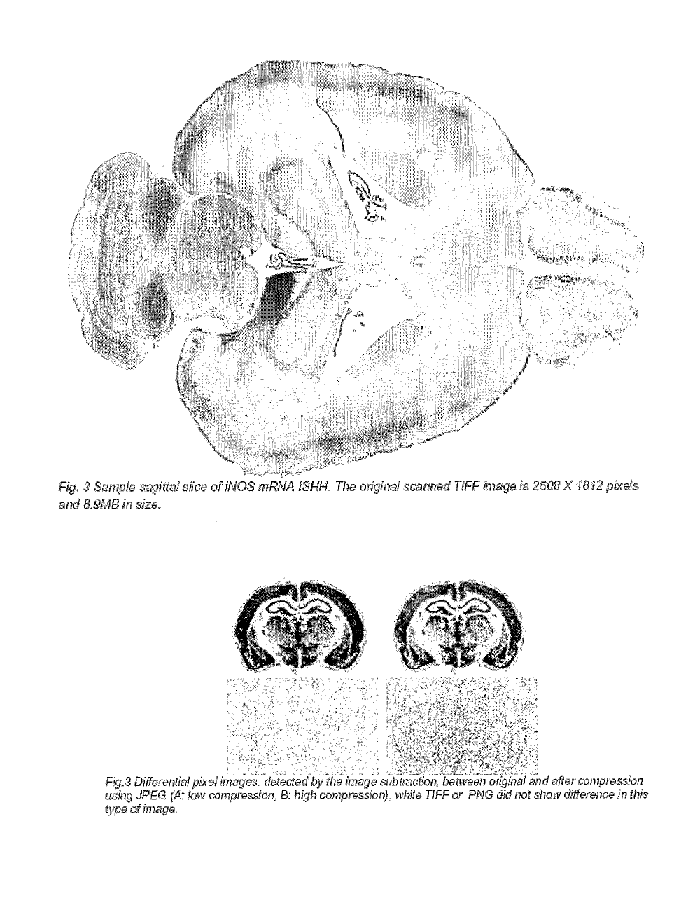

Thus, we believe that ISHH is the most feasible and reliable approach for analyzing gene expression in the brain. The inventors have improved ISHH experimental procedure itself; their protocol reduces the artifacts (uneven message and distortion of the brain sections), which introduce complexity to the registration of 2D images for 3D reconstruction using tape transfer system as described later. The distribution of constitutive type nitric oxide synthase (c-NOS) mRNA in cholinergic cells was examined using [35S] labeled ISHH (FIG. 2) in sections immunochemically stained for choline acetyl transferase (ChAT). Some of the sections seen in this figure are distorted and may be missing a part (or parts) of the tissue; of course, missing tissue may result in critical artifacts in the IMGEM reconstructed 3D data set. Example 2 provides a technique for minimizing such artifacts.

### EXAMPLE 2

### Tape-Transfer System

In order to eliminate damages to the brain slices during the ISHH process which introduces distortion, the inventors employed a new technique (CryoJane Tape-Transfer system, Instrumedics Inc., NJ), which allows the transfer of the cryostat sections to the slide glass without any damage. The tape transfer system enables the user to prepare frozen sections of paraffin-quality, as thin as 2 microns, wrinkle-free, uncompressed, fully intact and tightly bonded to the microscope slide. In the tape transfer process, sections are cut, transferred and tightly bonded to the microscope slide without ever being permitted to melt. Slow freezing of the tissue or brain produces large ice-crystals, which damage insoluble structural elements and cause displacement of water-soluble components. In the tape transfer process the tissue is snap-frozen to minimize ice crystal size. The frozen section is captured on the cold tape window, as it is being cut and is then transferred to the cold adhesive coated slide. The slide is placed in a UV chamber housed within the cryotostat and is exposed to UVs (360 Nm) via a short burst of approx. 8 msec. The glass slide has a polymer surface, which hardens under exposure to UVs and creates strong bonds between the slide and the tissue section.

Once the polymer is hardened into a plastic layer, the tissue cut is fixed perfectly on the slide and the tape is removed. The polymer of the slide is resistant to all types of solvents and dyes so the tape transfer method assures that tissue sections can be maintained unthawed even after mounting. Therefore, sections can be freeze-dried in the cryostat in about ten minutes or freeze-substituted in as little as ten seconds and then fixed “anhydrously” to preserve virtually all fine structures present in the tissue. Water-soluble enzymes, antigens and nucleo-proteins are also preserved in-situ, and with appropriate fixation and staining, true localization of enzyme and antigen activity can be visualized. The bond between section and slide is resistant to proteases, alkali and acids. During this process, the tissue sections remain perfectly frozen for allowing better morphology, enhanced contrast staining and distortion free sections (FIG. 3). This procedure prevents the loss of sections that can usually occur after rigorous protocols such as ISHH. Example 12 provides addition details of the tape transfer process.

### EXAMPLE 3

### Interactive Multiple 2D Gene Expression Maps from the Gene Expression Data

An image database was constructed capable of efficient storage, retrieval, presentation, manipulation and analysis of gene expression 2D image data. The gene expression 2D image data consists of ISHH experimental data from coronal brain sections and sagittal and horizontal data re-sliced from reconstructed 3D data sets.

Reconstruction is the abstract “rebuilding” of something that has been torn apart, a big part of reconstruction is then being able to view, or visualize, all the data once it's been put back together again. The 2D image data obtained from ISHH should be put back together to recreate how the brain looked before we sectioned it, we must put all the images of all these slices back together again, just as if we were putting the real slices of tissue back together again. Since all of these planes must be stacked back together to obtain the complete picture of what the tissue was. Initially the images are aligned manually and then Spatial Transformations and Image Registration techniques are used to align the images with each other. Spatial transformations alter the spatial relationships between pixels in an image by mapping locations in an input image to new locations in an output image. In Image registration typically one of the datasets is taken as the reference, and the other one is transformed until both datasets match. This is important as images must be aligned to enable proper 3D reconstruction for quantitative analysis. Using the Matlab Image Processing Toolbox, select points in a pair of images (using points from external Marker-based Automatic Congruencing technique which is described in Example 8) are interactively selected and the two images are aligned by performing a spatial transformation. The IMGEM registration module provides an affine registration, i.e. it determines an optimal transformation with respect to translation, rotation, anisotrope scaling, and shearing.

The reconstructed 3D dataset is represented as a three-dimensional array of density values arranged orthogonally in rows, columns, and planes to form a block of data in space. Each density is a single byte from 0 (black) to 255 (white). In the program (Slice Viewer, Orion Lawlor) the inventors define two separate right-handed coordinate spaces data space, centered on a corner of the density data and measured in individual voxels; and screen space, centered on the top left-hand corner of the display window and measured in screen pixels. Using homogenous coordinates we can use a single 4×4 matrix to map data space to screen space (the fourth coordinate implicitly taken as 1, to allow translation to be represented in the matrix). This matrix can then be inverted to map points from screen space back into data space.

To project the three-dimensional screen space onto the two-dimensional screen, a simple projection system isometric projection is used. In this system, the z coordinate of three dimensional points is simply ignored, and the x and y position is plotted on the two-dimensional screen. The main advantage conferred by this system is that objects do not shrink with increasing distance, allowing us to measure the size of objects without regard to position. For this reason, an isometric projection is commonly used in scientific visualizations of this kind.

To color each pixel on the screen, the location in the block of data must be found which corresponds to this pixel. Then one can apply the interpolation procedure to find an approximation to the density of the block of data at that location. To render this cross-section of the object to the screen, the program must first determine what section of the screen intersects the block of data. To do this, it assembles a polygonal intersection region from the intersecting line segments of the block's faces. These line intersections of the faces come, in turn, from each face intersecting its edges with the plane. These point intersections are assembled into a line segment intersection for each face, the line segments assembled into a polygon. This polygon intersection is then converted from line segments into spans of pixels running along the horizontal axis, and quantized to individual pixels (that is, the endpoints of the intervals are rounded to integers). This intersection is simultaneously clipped to the boundary of the computer screen. The intersection of the block of data and the slicing plane is now represented as a collection of horizontal line segments. There is one scan line for each y coordinate of the screen. Once this process—referred to as rasterization—is complete, the endpoints of each scan line are mapped from screen space to a location in data block space using the inverse mapping matrix. Because the mapping between spaces is linear (after all, it is accomplished using a matrix), we can save significant computational effort without loss of accuracy by only inverse-mapping the endpoints, then linearly interpolating locations in the data block between them. The interpolation procedure is then called upon to generate a density value at this location, and this density is displayed to the screen as the virtually sliced image pixels.

This embodiment may also incorporate counterstaining images with Nissl-stain, micro-ISHH images, Internet hyperlinks to PubMed, GenBank and other available information on the network. A true image format is desired to accurately store an image for future editing. Choosing the most appropriate true image format from dozens of existing formats is important for the success of IMGEM.

On a computer monitor, images are nothing more than variously colored pixels. Certain image file formats record images literally in terms of the pixels to display. These are called raster images, and they can only be edited by altering the pixels directly with a bitmap editor. Vector image files record images descriptively, in terms of geometric shapes. These shapes are converted to bitmaps for display on the monitor. Vector images are easier to modify, because the components can be moved, resized, rotated, or deleted independently. Every major computer operating system has its own native image format. Windows and OS/2 use the bitmap (BMP) format, which was developed by Microsoft, as the native graphics format. BMP tends to store graphical data inefficiently, so the files it creates are larger than they need to be. Although Mac OS can handle any kind of format, it is preferential to the PICT format, which more efficiently stores graphical data. Unix has less of a standard, but X Windows and similar interfaces favor XWD files. All of these formats support full 24-bit color but can also compress images with sufficiently fewer colors into 8-bit, 4-bit, or even 1-bit indexed color images.

However, one disadvantage of file compression is the occasional loss of image quality. Tagged image file format (TIFF) is a “loss-free”, 24-bit color format intended for cross platform use, and tends to be accepted by most image editors on most systems. TIFF can handle color depths ranging from one-bit (black and white) to 24-bit photographic images. Although, like any standards, the TIFF developed a few inconsistencies along the way; but nevertheless, this format will be the best format to store the original 2D data of IMGEM.

Since IMGEM will be presented on the World Wide Web, graphics formats have to be compatible with web browser. Current web browsers can handle graphics interchange format (GIF), Joint Photographic Experts Group (JPEG) and Portable Network Graphic (PNG). Most images and backgrounds on the web are GIF files. This compact file format is ideal for graphics that use only a few colors, and it was once the most popular format for online color photos. However, GIF has lost some ground to the JPEG format, due to the higher quality of JPEG for handling photo images. GIF images are limited to 256 colors, but JPEGs can contain up to 16 million colors, and they can look almost as good as a photograph. JPEG compresses graphics of photographic color depth better than competing file formats like GIF, and it retains a high degree of color fidelity. This makes JPEG files smaller and therefore quicker to download. Compression dynamics for a JPEG file can be defined, but since it is a format prone to lose image quality, the smaller we compress the file, more color information will be lost. FIG. 3 shows differential images between original and after compression using these three formats and the resulting file sizes. The original gene expression data (284 Kb, 654×438 pixels) is 8-bit gray scale image, GIF (296 Kb) and PNG (268 Kb) show no loss of image information, but JPEG 25 shows degradation of image in low compression (152 Kb) and high compression (24 Kb) modes (FIG. 3). If the complexity of the original image is low (284 Kb), GIF, JPEG low compression, JPEG high compression and PNG compress the file size to 172 Kb, 92 Kb, 16 Kb and 164 Kb respectively. By far the most promising “loss-free” format is PNG. For ease of calling up images over the Internet at today's limited bandwidth, JPEG will be used whenever quantitative information is not required.

The 2D data is presented as interactive images for fast initial display and on demand viewing of fine details. The images can be viewed without any large download. Web site visitors can interactively zoom-in and explore the images in real time. The user can then choose the precise section to manipulate for further analysis without using any software that needs to be downloaded and installed. The inventors incorporated ImageJ, an interactive multithreaded image processing and analysis application written in java. ImageJ has an open architecture that provides extensibility via Java plug-in as an applet so the user can start using the image processing application directly from the website to perform ROI analysis, change LUT to enhance the image in pseudo-color and other manipulations included within the IMGEM GUI. The inventors incorporated a powerful, standards-based, nondestructive annotation system that allows registered users to make both simple, intuitive annotations, which will enable them to save their regions of interest or other notes and these annotations will be non destructive and user specific.

### EXAMPLE 4

### 2D Image Acquisition

a. From Film Autoradiographs

Each film exposed to slides also contains a “standard” with a range of 14C radioactivity levels (14C and 35S have nearly identical emission energies) which are used to establish that the optical densities in the sections fall within the range of linearity of the film and to estimate the absolute level of radioactivity in the section. The standards are first digitized and used to verify that the most intense signal in the section lies within the linear range. The 14C standards are used to make a calibration curve which is applied to convert optical densities to dpm tissue equivalents. All sections are exposed on one film; the film background is assessed and, if necessary, the optical densities are corrected for film background.

The auto radiographic images of films are scanned at 1600 dpi and 12 bit gray scale image with plug in for Adobe Photoshop and adjusted to 1270 dpi. The scanned images are archived as TIFF files. Each coronal section image consists of 690×465=320,850 pixels=480 Kb (if it is 8 bit then 320 Kb). The image files will be converted into the web image file format, depending on the complexity of the image (for example, a 320 Kb TIFF image will be compressed to 180 Kb-325 Kb in GIF format and 160 Kb-285 Kb in PNG format). If the JPEG format is used, the file size will vary according to the complexity of the image and the quality of the compression (for example, a 320 kb TIFF image will be compressed to 17 Kb-165 Kb, but the reproducibility of the image would be very low). Thus we used high compression JPEG images for index, medium compression JPEG format to display qualitative images, and TIFF format to send quantitative images.

b. From Nissl-Stain

The Nissl-stain image will be scanned at 1600 dpi of 36-bit color image with plug-in for Adobe Photoshop and adjusted to a 24 bit image at 1270 dpi resolution. To minimize the differential signal intensity intra- or inter-section, image processing, subtraction of the background and equalization, may be performed. Each coronal section image consists of 465×690=320,850 pixels in RGB [symbol] Ö1.4 MB.

### EXAMPLE 5

### Setup for Working 2D Image Data Set

The image files will be converted into the web image file format. The file size after compression will depend on the complexity of the image. All 2D-gene expression data of the coronal, sagittal and horizontal brain sections will be stored in low or uncompressed JPEG format files and at the original resolution (1 pixel=20 μm×20 μm). From these images, low resolution JPEG medium compressed files (100×148 pixels) will be produced and stored for the index. Each file will be named by gene type, stain, direction of the cut, serial number of sections, and resolution with file format extension. One set of the image data from one brain section will have a file size of ˜2.7 MB. Since ˜1000 sections (20 μm) will be sliced from one rat brain, one set of the 2D image data from one brain will occupy ˜2.7 GB of disk space.

### EXAMPLE 6

### Retrieving the 2D Image Data

The 2D image data will be able to be retrieved by two modes: (1) Visual Selection Mode (VSM). In this mode, the user can select the target section by positioning the computer mouse on the whole brain model, side views for the coronal or horizontal slices and top views for the sagittal slices. As the user moves the pointer along the area, thumbnail index images in Nissl-stain will be dynamically changed. When the user clicks on the desired selection, a new browser window with multiple images will open (the user can select the number of images (9, 16 and 25), and can choose between ISHH and Nissl stain images). Next, the user can select the exact images to be retrieved by clicking on the multiple images. The selected images will be displayed in a new browser window. VSM allows the user to visually select entire 2D image data with a small whole brain model (80 selection points in a 160 pixel image). The download traffic time, which includes a low compressed JPEG image as the final retrieved image, will be <0.85 sec at 300 KB/sec transfer rate. (2) The second retrieval mode is a database search based on type of images (ISHH or Nissl-stain), gene, species, cutting plane etc to be displayed in a new browser window. Then a new browser window containing multiple images which match the search criteria will be displayed and the user can browse to the image data of interest. Since these images are not exact slices but a collection of slices scanned from autoradiograhical films, VSM mode of selection on these data sets was not used. This method is provided so as to facilitate the inclusion of historical gene expression data developed for other projects in to the data archive.

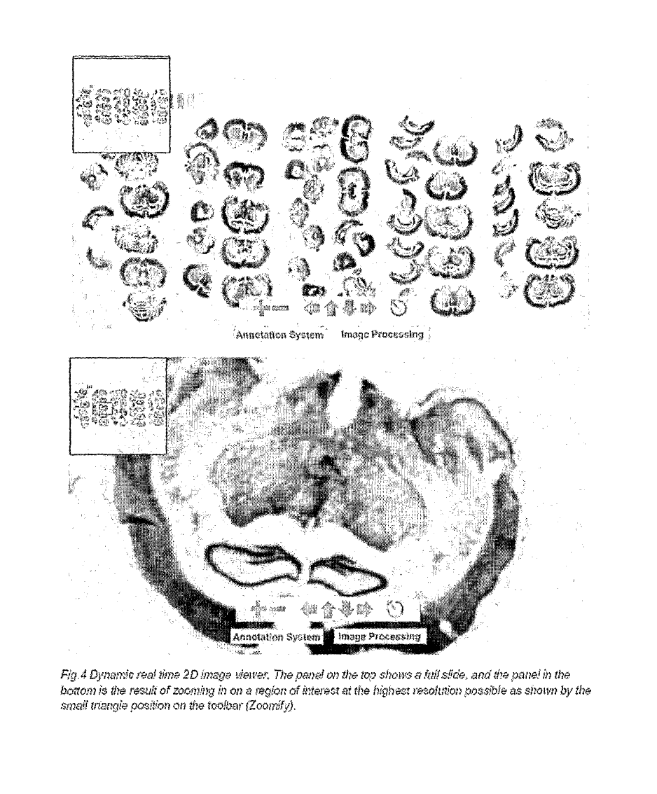

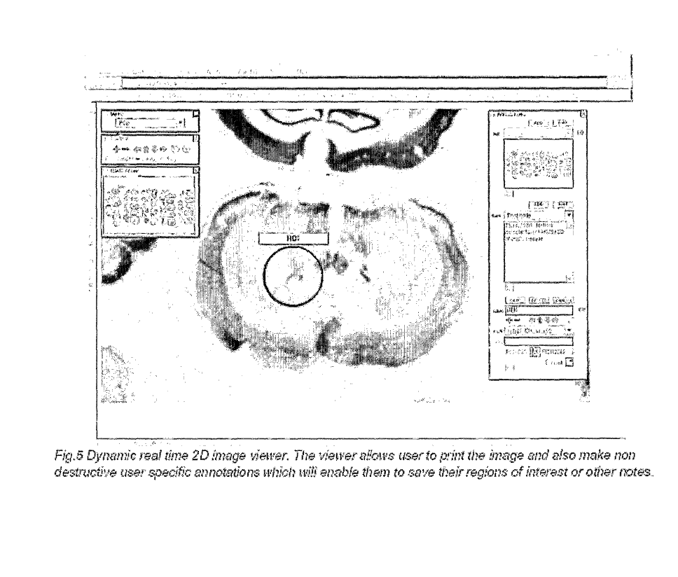

Web site visitors can interactively zoom-in and explore the images in real time. The 2D image is converted in to a file format for incremental access. The IMGEM 2D Viewer is then able to display any view of the brain slice without delivering any unneeded, undisplayed image data. The 2D image is copied several times at different resolution levels—from the original source resolution down to a thumbnail. Each of these levels is cut into many small tiles. All the tiles from all the levels are then incorporated into a single file system along with an index of the exact location in the file. This file is pyramidal—that is, like a pyramid, stacked from a thumbnail down to the highest resolution, level upon level. When the new file is viewed, the IMGEM 2D Viewer uses the index to request the lowest resolution tiles from the Web server and displays the thumbnail. Each pan and zoom causes a request for only a small additional number of tiles—those for the part of the image panned to, at the level of zoom desired. No tiles are ever delivered unless required for the current display—or for a display that is anticipated to immediately follow (intelligent pre-fetching). These requests for image data are all made via standard HTTP 1.1 Internet protocol. The only difference is that the Web server is providing parts of image files rather than entire image files. The user can interactively zoom in to the region of interest (FIG. 4) or the slice, and select ROI, and open the selected ROI in a different window with the image processing application to do further analysis. The download traffic time, which includes low or uncompressed JPEG image as the final retrieved image, will be <2 sec at 300 KB/sec transfer rate.

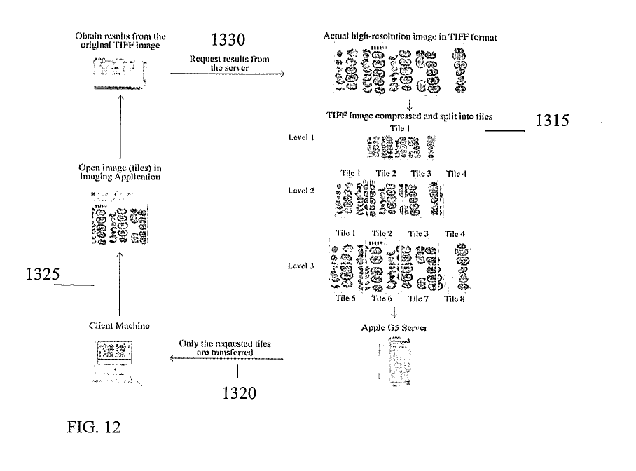

A specific embodiment is shown in FIG. 12. The system involves compressing the TIFF images into JPEG so the browser can display them and splitting the images into tiles so that only the relevant portions of the image are downloaded 1315. If the user wants to view the slices (middle portion) at say 100% zoom Tile 1 from Level 1 is displayed. If the user wants to view the same slices at 200% resolution Tiles 2 and 3 from Level 2 are displayed and for 300% resolution Tiles 2, 3, 6 and 7 from Level 3 are displayed. Only the requested tiles are transferred 1320. The 2D Database also features an Image Processing and Analysis application for the archived TIFF images. As mentioned above, TIFF images cannot be easily downloaded and displayed on the web. Hence the system embodiment displays the image to the user in a preview mode on which he can perform Image Processing and Analysis 1325, but the actual results are retrieved from the actual TIFF images 1330. For example, requesting a 300% zoom on this image retrieves Tiles 2, 3, 6 and 7 from Level 3. When the user zeroes in on his region of interest, he can open the image (Tiles 2, 3, 6 & 7) in an image processing application, which serves as the preview mode image. This is a unique image processing application, which can communicate with the server when the user performs the processing and analysis and returns the results from the actual quantitative (TIFF) image on the server.

### EXAMPLE 7

### Manipulation and Analysis of the 2D Image Data

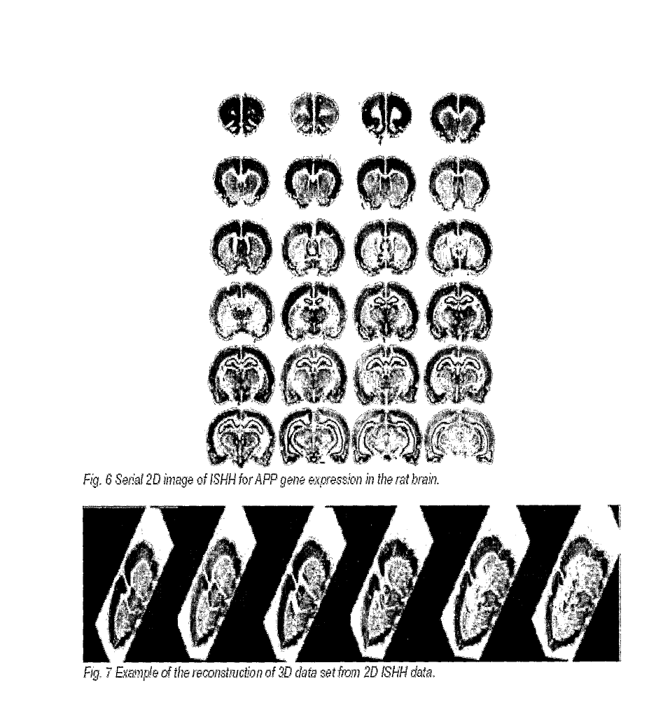

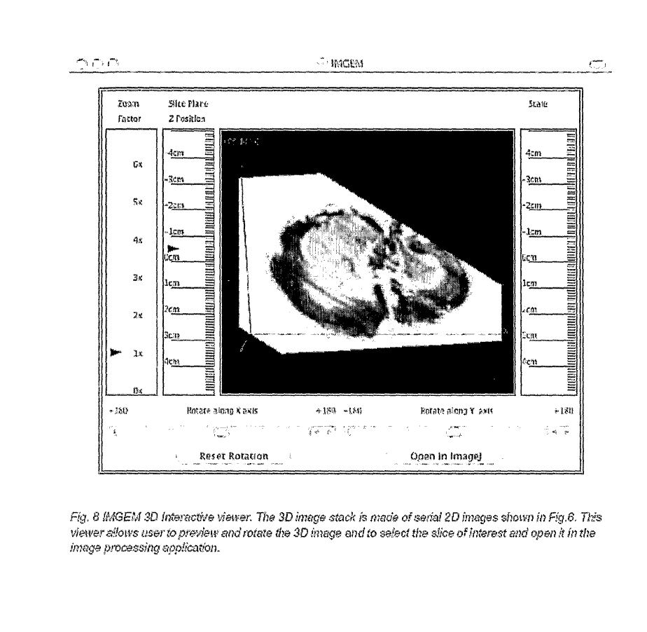

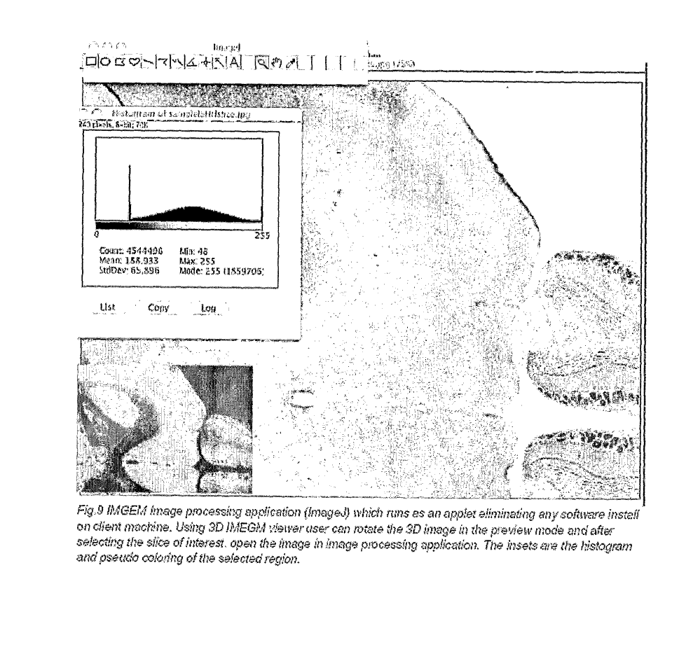

The images are displayed as interactive images which the user can zoom in real time without any delay. A powerful, standards-based, nondestructive annotation system is also provided that allows registered users to make both simple, intuitive annotations, which will enable them to save their regions of interest or other notes and these annotations will be non destructive and user specific (FIG. 5). From the IMGEM 2D viewer the user will be able to print the image as displayed (the specific region of interest) for reference purposes. The image-processing program, ImageJ written by Wayne Rasband of the Research Services Branch, National Institute of Mental Health is incorporated in to IMGEM. ImageJ will run on Java environment as an online applet. The image processing program will calculate the area and pixel value statistics of user defined selections (ROI). It performs geometric transformations such as scaling, rotation and flips; and it also supports standard image processing functions such as drawing, zoom, application of user-defined LUT modification, thresholding, making binary, contrast and brightness manipulation, sharpening, smoothing, and other filtering. Since ImageJ is based on an open architecture; addition of user-written plug-ins will make it possible to solve almost any image processing or analysis problem.

Furthermore, ImageJ supports any number of windows simultaneously with the only limitations being the users available RAM in the client. We are scripting an add-on to this software, which allows for remote manipulation of image data by IMGEM users. Thus, users will be able to manipulate images in the preview mode, and then send a request to the server for the final high resolution image. This procedure may not be so important for retrieving single 2D image data, but for the quantitative analysis of multiple 2D image or 3D data sets, this capability is critically important. Manipulation of multiple 2D or 3D image data will involve heavy traffic of data over the network. Without an integrated preview mode, due to the limitations of current network transfer rates, the manipulation of multiple image data is burdensome and impractical.

### EXAMPLE 8

### Interactive Multiple 3D Gene Expression Maps from the 2D Gene Expression Maps

3D reconstructions have become routine particularly with those imaging techniques that provide virtual sections, such as CT, MRI, and CLSM. Reconstructions from physical sections, such as those used in histological preparations, have not experienced an equivalent breakthrough, due to inherent shortcomings in sectional preparation that impede automated image- processing and reconstruction. Thus, Jacobs et al. applied MRI to construct mouse 3D structural atlas [3], but this method is not be able to apply visualization of gene expression data. The increased use of molecular techniques in morphological research, however, generates an overwhelming amount of 3D molecular information, stored within series of physical sections. This valuable information can be fully appreciated and interpreted only through an adequate method of 3D visualization. Key questions which arise for this project are “how efficiently the 3D data sets is reconstructed from 2D image data?” and “how efficiently image data is presented in realtime?”

According to one embodiment, IMGEM invention pertains to a 3D voxel gene expression map of the C57/black mouse brain from presently available 2D section images. Because precision controls the efficiency and accuracy of 3D segmentation, for this goal critical factors include appropriate alignment of section images and variation of ISHH signal intensities. Streicher et al. Introduced External Marker-based Automatic Congruencing (EMAC), concept for realignment of the mechanical sectioned slice images and for geometric correction of distortion. [4]. In this method, drill holes introduced into a permanent embedding medium prior to sectioning serve as EMAC of digital images captured from the microscopic sectional views. These markers have to be visible only in one of the viewing modes (e.g. in the phase contrast view), whereas all additional views (fluorescence or brightfield views), visualizing different aspects of the same section, are automatically congruenced in accordance with by the same macro. Streicher et al. recently applied this method to gene expression [5], and succeeded to show qualitative distribution of gene expressions. (http://www.univie.ac.at/GeneEMAC/). Although the Streicher et al. method may not directly apply to the semi-quantitative gene expression database, concept is very important and useful, and has been adapted for ISHH. Since the inventors did not want to have obstacle as a result of auto radiographic images and x-ray film only has information as silver grain (there is no alternative marker), the inventors put an external marker on the outer edge of the brain specimen. The inventors used 14C micro-scale strip for the marker, because 14C has similar energy level of 35S, which the inventors use to make riboprobe for ISHH. The external radioisotope marker (ERM) is embedded with the brain in OCT compound, sliced with the brain sample and picked up on the plastic tape. The coordination between brain slice and ERM is kept throughout the experiment and exposed to the x-ray film. Since inside structure of the brain slice will be preserved, after construction of TIFF stack in NIH image from archived 20 μm TIFF images, semi-automatic alignment can be done with Align macro (Chi-Bin Chien, Dept. of Biology, UC San Diego) followed by further manual adjustments. Data file sizes of raw 3D data set for ISHH and Nissl-stain will be 320 MB (320 kB/section×1000 sections) and 960 MB (960 KB/section×1000 sections), respectively. These 3D-data sets will then be connected via the ROI and the wire frame data to the informatics database of the IMGEM. The demonstration of manipulation of 3D image data can be found at http://imgem.ucf.edu, whose display and information is incorporated by reference. The data handling concept, using IMGEM's preview mode, as explained above, is important for manipulation of the 3D data. If the users have to download 960 MB of data before they are able to begin any image manipulations, this might require more than 50 min, using a 300 KB/sec network connection. This is not feasible. In order to circumvent this problem, the inventors use a wire frame or surface model or a small low-resolution data set to manipulate image data in IMGEM's preview mode, and then transfer the final results in JPEG or PNG. The first steps of 3D manipulation will be made by the combination of Java Applets and Servlets. Once the user gets the plane of interest in the 3D preview mode, the user can obtain a higher resolution 2D image from the 3D by performing a virtual slicing and then do the image processing. Whatever processing that the user performs on his client on the 2D JPEG image will be recorded automatically, and when the user is done he can get the quantitative dataset of the image with all the image processing operations performed on the original TIFF 2D plane obtained from the 960 MB TIFF stack. This operation is made in combination of XML and Java Servlets.

### EXAMPLE 9

### Reconstruction of 3D Data Set from 2D Image Data

2D coronal serial section images from ISHH and Nissl-stain, in TIFF format, will be reconstructed into 3D data sets using NIH image stack command. Since the brain slices are sectioned at 20 μm and the ISHH and Nissl-stain images are taken at 1270 dpi×1270 dpi (1 pixel=20 μm×20 μm), voxel of the reconstructed 3D data set will be 20 μm×20 μm×20 μm. Data size will be 320 MB (465×690×1000 voxels) and 960 MG (465×690×1000 voxels×RGB), respectively. FIG. 7 demonstrates a sample of the construction of a 3D data set from 2D image data (FIG. 6). In this case, a cut was made through the bottom half of the 3D data to illustrate a horizontal cut of the brain. In this example, since there are only images from every 12 serial sections, the thickness by interpolation was added. The provided horizontally-sliced image is not the best quality, but the 3D data set may be constructed from every serial section without interpolation; thus, the horizontally-sliced images will be the same high quality as coronally-sliced images.

### EXAMPLE 10

### Visualization of the 3D Data Set

Manipulation of 3D image in real-time on the client terminal will be a challenge if the 3D data set is localized. It takes about 18 min to transfer ISHH 3D data set (320 MB) and 56 min to transfer Nissl-stain 3D data set (960 MB) at 300 KB/sec connection, therefore manipulation of local data is not practical using currently available network technology.

Thus, the inventors used thin client technology to facilitate real-time manipulation of the 3D data set. The user can manipulate the 3D view by positioning of the mouse around the model; and if it is necessary, the user can make dissections by re-slicing. Once the view is satisfactory, the user can send a command to retrieve the final image. The download traffic time, which includes a rendered 3D image in low compressed JPEG format as the final retrieved image, will be <1.5 sec at 300 KB/sec transfer rate.

### EXAMPLE 11

### Manipulation and Analysis of the 3D Data Set with Integration of 2D Image Data

In contrast to a 2D Visualizing system, the 3D Visualizing system needs to be highly interactive to offer the user a smooth experience while viewing the 3D Image. Web scripting languages like JavaScript, VBScript do not have the functionality to display 3D Images.

Browser plug-ins like Shockwave, Real Player and Windows Media Player have the ability to display 3D but only as a movie, which is not interactive.

Hence a programming language that is web enabled and highly interactive was needed. The inventors choose to use Java as the programming language for the 3D visualization system, which introduced the concept of Applets. An Applet is a software component, which can run in the context of a web browser. An Applet is lightweight, platform independent and is backed by a powerful programming language—Java.

The inventors designed a 3D Visualizing system embodiment based upon Orion Lawlor's SliceViewer Component. The 3D Visualizing system is capable of displaying the 3D reconstructed images, which are in RAW format. But as we mentioned above, the complexity of this system is increased because of the volume of data (100 MB-500 MB) being handled.

The user may not be patient enough to download such a huge volume of data and even if he does, loading this data on his machine depends upon the computing power and resources of the client machine. The best way to overcome this problem is to display a preview image in the client machine. The inventors created scaled down versions of the actual images, which are approximately 100 KB-2 MB in size. This is the optimal size, which can be easily downloaded and displayed in the client machine.

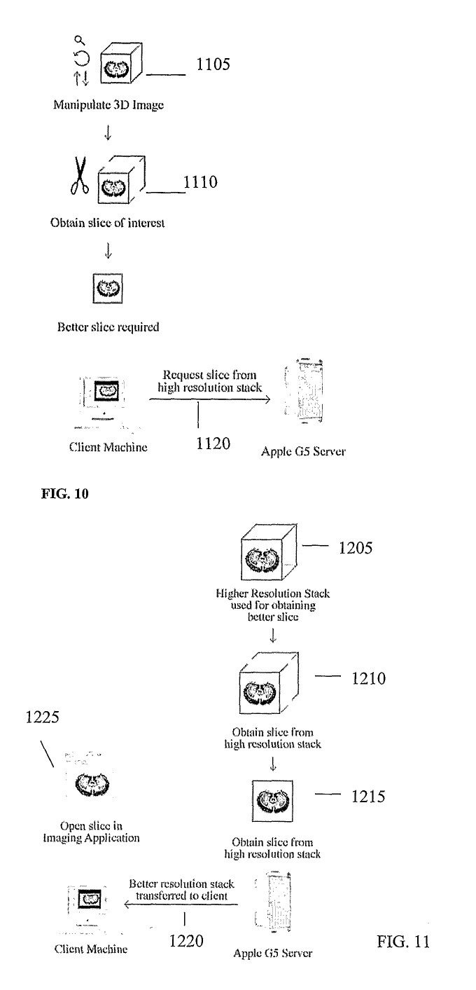

This image loads up quickly in the client machine. Turning to FIGS. 10 and 11, an image can be rotated in 3D space and the user can zero-in on the slice he wants to analyze further 1105. When the user selects his slice of interest 1110, he can open the image in an Image Processing application. The problem here is that this image is good for 3D Rotation and Manipulation but it is not good enough for image processing and analysis. The same slice can be obtained from the original 3D Image stack for Image Processing and Analysis. But the size of the slice obtained can be huge and it may cause the same problems again viz.: (1) Network bandwidth and (2) Client machine's computing power. These issues are addressed by creating an image stack, which is smaller in size than the original stack but is good enough to support image processing. This stack is used to obtain a high-resolution stack, which can be used to do image processing and analysis on the client. When the user selects a slice of interest after manipulating the preview 3D image he can request for a higher resolution stack 1120. The parameters resulting from these manipulations are typically: (1) Angle of Rotation along X-axis; (2) Angle of Rotation along Y-axis; (3) Slicing Position and (4) Magnification.

These parameters are sent as plain text to the server. The high-resolution slice is extracted from the high-resolution image stack using these parameters 1205, 1210, 1215. This image is sent to the client over http protocol 1220, which is opened in an Image Processing Application 1225.

An example of a system that enables users to manipulate 3D models of the brain in real-time, which employs HTML and applet is demonstrated at http://imgem.ucf.edu/3D_dataarchive.htm. When users are satisfied with the manipulation in preview mode, they can retrieve the final high quality image. The inventors started with an HTML/Java applet system, and gradually integrated the 3D portion of IMGEM into VRML with Java 3D. In this way, IMGEM will be functional and ready for the upcoming future transitions to real-time manipulation of 3D data, when network speeds are increased.

IMGEM's 3D view manipulation allows users to rotate the 3D image stack in the preview mode, which is a low resolution image 3D image of the original image data. IMGEM 3D viewer allows the user to slice the 3D data at any vantage point. Selected areas of the 3D data set can be retrieved as serial 2D sections to display. The 2D virtual slice obtained by the user is of medium resolution, which eliminates the need for downloading of large amounts of data to the client machine. The 2D section is opened in the integrated image processing application, ImageJ (FIG. 9) and whatever processing that the user performs on his client on the 2D JPEG image will be recorded automatically. When the user is finished, he can obtain the quantitative dataset of the image from the server, with all the image processing operations performed on the original TIFF 2D plane obtained from the 960 MB TIFF stack. The original data is sent to the client machine in a zip format which allows for faster download.

In addition to dealing with the issue of network bandwith and processing power on the client machine, the inventors have realized that dealing with the shear size of the original image stack is an issue that must also be addressed. Opening such a huge image is a time consuming and memory intensive operation. For this reason, as discussed above, the loading and manipulation of this image is kept in the server. This Image Processing Application is similar to the one, which is described in Example 7 above. This application can communicate with the server when the user performs the processing and analysis and returns the results from the original image stack. But there is one important difference between the two systems.

Whereas for the 2D System the quantitative image is available in TIFF format, the 3D System stores it in stacked image format (RAW). Hence the Server-side processing and analysis system has the additional task of retrieving the proper slice of interest from this image stack. After doing this, the results of any processing and analysis conducted by the user on the client can be repeated with this slice in the server and the results can be returned to the user.

Retrieving the slice of interest from the original image stack (100 MB-500 MB) becomes a complex process due to the memory occupied by the image. Even with the high-end resources of the server, the inventors have experienced a number of problems in implementing this system embodiment. In particular, the inventors realized and addressed the following specific problems: (1) Data structure limitations; (2) Java's File operations and (3) Storage of retrieved values.

Data structure limitations: Loading the original stack into 3D arrays (like was done for the preview image stack) is not possible due to limitations imposed by the Java Programming Language (which is used to develop the Server-side Image Analysis module). The size of the arrays that can be created depends on the memory allocated to the JVM—Java Virtual Machine. The Java Virtual Machine is software that converts intermediate Java Code into Machine Language code and executes it. Loading such a large amount of data for the extraction of a slice, which is less than 5% in size of the total image stack, is not reasonable and practical. The inventors created a method to compute the file locations in the image stack where the pixel values for the slice of interest are located. After obtaining the list of file locations where the required pixel values are located, these location values are sorted in ascending order. The image stack file is traversed sequentially (as opposed to a random access if the file locations are unknown) and only the required pixels are loaded into memory.

Java's File operations: As already mentioned embodiments of the subject invention employ, the Java Programming Language for the Server-side Image Analysis module. Java Servlets are the link between this Analysis module and the Visualizing system. Servlets are Java applications, which can run in a web-server or an application-server, perform server-side processing and provide dynamic content to the client. Since they are written in Java, they are portable between servers and operating systems. Java's platform independency is achieved using interpreted byte-code operations. The source code is first compiled into byte-code (intermediate code). This code is platform independent. This code can then be interpreted by the JVM (Java Virtual Machine) for the specific platform. The file I/O, which we mentioned in the previous section, suffers due to interpreted byte-code operations. This issue was addressed by employing native C++ code to perform the file I/O operations.

Storage of retrieved values: After obtaining the file locations and the associated pixel values, the inventors realized a problem with efficient storage of these values. The inventors realized that a data-structure was needed that could store key-value pairs ([file location, pixel value]), have an efficient look-up time (order of 1) and have a huge storage capacity (without loss of performance). The inventors tried a hashtable data-structure, which is readily available in Java. But the Hashtable available in Java is a Generic Implementation, which can hold all types of objects. The problem with this implementation is that it is designed to hold objects but its performance declines with increase in size. To address this issue, the inventors devised a customized hashtable, which holds only integer values and is implemented using numerical arrays.

### EXAMPLE 12

### Protocol Embodiment for Tape Transfer of Tissue

### Needed Utensils:

Cryostat Machine (Leica CM1850 or 1800), Tape Windows, Hand Roller, Adhesive-Coated Slides, Specimen Disks, New Disposable Blade: Thin blade for thin tissue and thick blade for bone and thicker tissues, Flash Pad Mechanism, Freezing Media

### Optional Utensils:

Small, fine-tipped painting brush; Fine point forceps.

### Procedure:

1. *NOTE: Before procedure is preformed, turn on the Electronics Control Unit of the Cryostat Machine, which powers UV Flash Pad Mechanism. It takes around 20-30 minutes for unit to power up. (On/off switch can be found on side of control unit).

2. Mounting:
a. Mount specimen onto Specimen disk by placing Freezing Media (standard freezing media) in a liberal amount upon the surface of the disk.
b. Push disk into dry ice so that it is firmly secure and does not cause spillage of media off of disk.
c. Place in a desired position, the previously (dry ice) frozen specimen onto Specimen disk the moment that the media's edges begin to turn from a clear to creamy white color.
d. Allow media to completely harden around and under the specimen for ˜10-15 minutes.
e. Cover specimen fully with media so that a thin layer of media is visible over the specimen. Allow to harden for 15-20 minutes.
f. Remove from dry ice and fix the Specimen disk tightly into the specimen clamping head on the cryostat machine using the tightening screws. During this time orientation of specimen disk can be corrected using moveable tightening screw.

3. Replace disposable blade as necessary using black lever to release blade.

4. Set Micron width using spinning dial. (10-20 Microns on average).

5. Set Cryostat Temperature: −24 to −29 degrees Celsius.

6. Adjust Cryostat Horizontal buttons until Specimen comes just millimeters from newly replaced disposable blade.

7. Preparation of Tape Windows:
a. NOTE*: Tape strips Should be at cryostat temperature (usually around Negative 24-29 degrees Celsius). Failure to bring these strips to correct temperature before application to tissue causes the tape to loose adhesiveness.
b. The tape strips (windows) are applied to the media specimen using the Hand Roller in order to stick specimen upon tape.
c. For smaller specimens and to place a greater amount of specimen samples upon one Adhesive-Slide: Cut the pink tape strips into halves or even thirds lengthwise. They can later be applied to the Adhesive-Slides one at a time.

8. Slicing:
a. Remove Media covering until tissue is about to be exposed. For example, for brain tissue when desiring coronal sections . . . slice and dispose with fine-tipped painting brush until Olfactory Bulb is almost exposed.
b. Remove Tape window cover off of tape strip so that the adhesive side tape is exposed. Place tape according to direction given on the tape strips themselves so that the tape is top-to-bottom according to those directions.
c. Place non-adhesive edge of tape as close to the bottom of the specimen media as possible: See diagram below for instruction . . .
d. After Tape strip is applied by simply brushing the tape against the tissue sample, strengthen its grip on the tissue by utilizing the Hand Roller and firmly rolling the tape against the specimen.
e. Turn Cryostat Hand-wheel until bottom of tape strip nearly touches the knife holder. AT THIS POINT: Take Fine Tipped brush and softly lift the bottom of tape strip so that when Hand-wheel is turned, tape does not crumple up and fold over. While slightly lifting up end of tape strip, continue turning of Hand-wheel until a desired slice of specimen has been cut.
f. This can be repeated multiple times if multiple samples will be placed on one Adhesive-Coated Slide

9. Placement onto Adhesive-Coated Slides:
a. NOTE*: Adhesive-Coated slides MUST be kept at Cryostat temperature prior to use!!!
b. Remove the protective plastic cover off of slide so that the adhesiveness area is exposed.
c. Take previously sliced sample with adhesive side down and place onto Adhesive-Coated Slide in desired order and multitude.
d. Use hand roller to press tape strip onto Adhesive-Coated Slide. (*Note: use quite a bit of force with this, as it will produce greater results and less damaged tissue when tape strip is removed in later step.
e. After the tape strips are firmly mounted on Adhesive-Coated Slide, place slide into the UV-Flash Pad Mechanism and close cover lid.
f. Slide black switch across until Violet flash is produced.
g. Remove slide from UV-Flash Pad Mechanism.
h. Using fine-tipped forceps, SLOWLY remove Tape strips from Adhesive-Coated slide, by pulling away from slide going straight back toward other side of tape.
i. Sample should remain attached to Adhesive-Coated slide if steps were followed correctly.

10. From this point, staining, freeze-down, or other treatments can be applied directly to mounted slide.

### EXAMPLE 13

### Protocol Embodiment for Probe Hybridization: For Use of 3-D Gene-Expression Using Scan-Array Machine and Mounted Slides

### PCR:

1. A clone cDNA library, (e.g. Unigene), is required for PCR. This DNA plasmid is specific to certain genetic expressions and is interchangeably used to articulate a complete three-dimensional composite of its expressions.

2. Once the plasmid is prepared, 1.0 μl/tube is transferred to PCR mixture of compounds described below.

3. The key to this procedure is the immediate introduction of cy3/cy5 into the preliminary PCR and proceeding with using that product for the Hybridization of the brain tissue.

4. The Polymerase Chain Reaction is carried out using given temperatures and time.

5. After the PCR product is achieved, it can be stored, yet an immediate usage of this product is recommended for attaining best results.

6. Run final product on agarose gel to detect visible desired base pair band.

PCR Set Up For Fluorescent DNA Probe:

| | Sample # = 1.0 + 1.0 = | 2.0 | |
|---|---|---|---|
| dUTP (cy3 or cy5) | 2.0 μl × 2.0 = | 4.0 | μl |
| dA, C GTP mix (2.5 mM each) | 1.0 μl × 2.0 = | 2.0 | μl |
| M13 forward primer (1.38 pmol/μl) | 1.4 μl × 2.0 = | 2.8 | μl |
| M13 reverse primer (1.26 pmol/μl) | 1.5 μl × 2.0 = | 3.0 | μl |
| Buffer 10× | 2.0 μl × 2.0 = | 4.0 | μl |
| Taq DNA polymerase (5 μ/μl) | 1.0 μl × 2.0 = | 2.0 | μl |
| MBG water | 10.1 μl × 2.0 = | 20.2 | μl |
| Template DNA (Plasmid) | 1.0 μl × each tube = | 2.0 | μl |
| Total | 20.0 μl | 40.0 | μl |

Run PCR Reaction Using Following Steps:

| | | |
|---|---|---|
| Denature | 94° C. | 2 min. |
| Cycles: | 45 | |
| Denature | 94° C. | 30 sec. |
| Anneal | 61° C. | 30 sec. |
| Extend | 70° C. | 2 min. |
| Final Extension | 70° C. | 10 min. |
| Hold | 25° C. | — |

Primer Calculations:

| | | | |
|---|---|---|---|
| Final Concentration | 0.1 | μM | 0.1 pmol/μl |
| M13 forward original concentration | 1.4 | μM | 1.4 pmol/μl |
| Adding volume/tube (20 μl) | 1.45 | μl | |
| M13 reverse primer (10 pmol/μl) | 1.3 | μM | 1.3 pmol/μl |
| Adding volume/tube (20 μl) | 1.59 | μl | |

### Purification:

### Using Qiagen 's (Valencia, Calif.) QiaQuick PCR Purification Kit, Purify Resulting PCR Product Prior to Hybridization.

1. Pre-treat the columns placed in collection tube by incubating 100 μl of QiaQuick PB buffer for 5 minutes and then centrifuging at 14,000 rpm for 1 minute.

2. Add 260 μl of QuiQuick PB buffer to the sample tube.

3. Mix well by flicking tube, and then briefly spin down by centrifugation.

4. Load the sample onto the pre-treated columns.

5. Centrifuge at 6000 rpm for 1 minute.

6. If the column at this time is still not completely dry, centrifuge for an additional 1 minute at 6000 rpm. When dry the column should be visibly pink if cy3 was used as the fluorescent marker or blue if cy5 was used, and the reaction was successful. *Note: In some cases visibility may be difficult to notice, yet the reaction could still have been successful. A way to test this is: After purification is complete, an agarose gel is run to obtain a correct band signal. If this desired band is obtained without noticing a visibly pink or blue column, then the reaction was successful regardless.

7. Discard flowthrough. Place the column into the same collection tube.

8. Wash with 600-750 μl of QiaQuick PE buffer, being careful that the tube doesn't become excessively full. Centrifuge at 14,000 rpm for 1 minute.

9. Discard flowthrough. Place the column back into the same collection tube.

10. Centrifuge at 14,000 rpm for an additional 2 minutes to remove residual wash solution.

11. Place the column into a clean, 2 mil microcentrifuge tube.

12. Add 50 μl of nuclease-free, Molecular Biology Grade Water. Incubate for 3-5 minutes and then centrifuge at 14,000 rpm for 1 minute.

13. If the column still shows residual probe, add another 30 μl of nuclease-free, Molecular Biology Grade Water. Incubate for 1 minute and then centrifuge at 14,000 rpm for 1 minute.

### Checking Concentration and Purity of DNA:

1. Use Beckman DU650 to run your sample to check for consistent concentrations and purity of DNA.
a. Calibrate DU650 with a blank sample (Molecular Biology Grade Water) at wavelength 260, 550 and 650 nm.
b. Measure absorbance of the DNA probe (80 μl) at 260, 550 and 650 mn.
c. Determining the volume of probe to use per hybridization.
   i. Measure the probe's absorbance by using the entire undiluted volume of probe.
      1. 550 nm for Cy3
      2. 650 nm for Cy5
   ii. The optimal amounts of labeled probe when using BD Atlas Glass Hybridization Chamber with 2.1 ml BD GlassHyb Hybridization Solution are the following:
      1. Cy3: OU₅₅₀=0.010
      2. Cy5: OU₆₅₀=0.010
   iii. The optimal amount of probe to use in a single hybridization is quantified in absolute optical units (OU₁) of probe. OU is calculated from A as follows:
   iv. OU=AXV
   v. V: Volume of probe in ml.
   vi. To calculate the optimal volume of the probe in microliters, use the following equation:

Vopt(μl)=(1000×0.010)/A

### Hybridization:

Any remaining volume that isn't used for Hybridization nay be stored at −20° C. in the dark for up to 2 months.
*Note: all solutions are to be made of Molecular Biology Grade Water.

1. Using pre-mounted slides, transfer slide into 10 mM solution of PBS (˜30 ml) in a 50 ml tube and incubate at room temperature for 15 minutes while rotating on an orbital shaker.

2. Proteinase K solution is made: (1 μl prot. K stock/1 ml prot. K buffer, new). This is to be preheated for around 20 minutes at 37° C. before it can be used.

3. Transfer the slide to the proteinase K. solution and incubate for exactly 25 minutes at 37° C. without rotation. *Note: Do NOT extend this incubation period.

4. Remove from incubator, and increase incubator temperature to 60° C.

5. Transfer slide to glycine solution (0.75 g/100 ml of 10 mM PBS) and incubate for 5 minutes at room temperature while rotating.

6. Transfer slide to new glycine solution and incubate another 5 minutes at room temperature while rotating.

7. Make 25 ml trithanolamine (TEA) solution:
a. Add 325 μl of TEA to 25 ml of MBG water.
b. Adjust the pH to 8.0 by adding 80 μl of glacial acetic acid.
c. Right before using, add 62.5 μl of acetic anhydride to the solution.

8. Transfer the slide into the TEA solution and incubate for exactly 10 minutes at room temperature while rotating.

9. Transfer slide into 2×SSC solution and incubate for 15 minutes at room temperature while rotating.

10. Transfer slide into new 2×SSC solution and incubate for another 15 minutes at room temperature while rotating.

11. Pre-warm prehybridization solution (2 ml/slide—enough to cover entire surface of slide) in a 15 ml tube in 60° C. incubator for 5-10 minutes.

12. Place slide on tray and pipette the 2 ml evenly so that entire slide is saturated in the pre-warmed, prehybridization solution.

13. Cover slide with Parafilm strip so that no evaporation occurs.

14. Incubate slide for 60 minutes at 60° C. without rotation.

15. Make hybridization mixture:
a. Add Fluorescent probe (pre-calculated) to 2 ml of pre-warmed prehybridization mixture and vortex to make sure it is well mixed.

16. Remove prehybridization mixture briefly (without letting dry) and proceed to pipette the ˜2 ml of Hybridization solution containing probe onto the brain sectioned slide so that entire slide is covered in solution.

17. Incubate at least 18 hours at 60° C. in hybridization tube.

### Washing:

Label four Wash Containers (Green Caps): Wash 1, Wash 2a, Wash 2b, Wash 3. Perform all washes at room temperature on an orbital shaker. Do not let slides dry at any time during procedure.
These solutions must be made prior to washing:

1. Wash 1: 22 ml BD GlassHyb (BD Biosciences; San Diego, Calif.) Wash Solution

2. Wash 2a: 2 ml BD GlassHyb (BD Biosciences; San Diego, Calif.) Wash Solution+20 ml 1×SSC

3. Wash 2b: 2 mil BD GlassHyb (BD Biosciences; San Diego, Calif.) Wash Solution+20 ml 1×SSC

4. Wash 3: 22 ml of 0.1×SSC

1. Immediately place Hybridized slide into Wash 1 and incubate for 10 minutes.
2. Transfer to Wash 2a and incubate for 10 minutes.
3. Transfer to Wash 2b and incubate for 10 minutes.
4. Transfer to Wash 3 and incubate for 10 minutes.
5. Rinse briefly with MBG water.
6. Using a new, clean Wash Container, centrifuge at 1500˜2000×g for 5 min.
7. After this is dry, scan using Scan-Array machine:
Scanning with ScanArray Express:

1. ScanArray Express MicroArray Scanner Software by PerkinElmer Lifesciences.
a. Packard Biochip Technologies MicroArray Scanner Hardware (A Packard Biosciences Company).
b. Setting up ScanArray:
   i. Turn Packard Biochip MicroArray Scanner on and notice both Power and Ready buttons become green.
   ii. Open ScanArray Express software.
      1. Click on “Configure” in left-hand column controls.
      2. Select Tab: “Basic Information”
         a. Click on Scan resolution and set to 5 μm.
         b. Set Scan speed to “Half”.
      3. Select Tab: “Fluorophores”
         a. Set Gain PMT % to 70.
         b. Set Laser Power % to 70.
         c. Set Fluorophore to Cyanine 3.
      4. Select Tab: “Sensitivity Calibration Areas”
         a. “Area top left (mm)” should be 16.50, 62.76.
         b. “Area width and Height (mm)” should be 3.33×2.95.
      5. Select Tab “Sensitivity Calibration:
         a. “Average spot size (μm)” should be set to 100.
         b. “Target Signal Sensitivity (%)” should be set to 90.
         c. Check to make sure the boxes: “Keep PMT gain fixed” and “Vary laser power” are checked.
            2. Insert Hybridized slide containing tissue to be scanned into scan portal.
            3. Make certain lasers 1 and 3 are activated and are warmed up for 15 minutes prior to scanning.
            4. Select Scan to proceed to yield a fluorescent image of the Hybridized tissue.

### REFERENCES

1. Hecksher-Sorensen, J. and Sharpe, J., 3D confocal reconstruction of gene expression in mouse, Mech Dev, 100 (2001) 59-63.
2. Louie, A. Y., M. M. Huber, et al. (2000). “In vivo visualization of gene expression using magnetic resonance imaging.” Nat Biotechnol 18(3): 321-5.
3. Jacobs, R. E., Ahrens, E. T., Dickinson, M. E. and Laidlaw, D., Towards a microMRI atlas of mouse development, Comput Med Imaging Graph, 23 (1999) 15-24.
4. Streicher, J., Weninger, W. J. and Muller, G. B., External marker-based automatic congruencing: a new method of 3D reconstruction from serial sections, Anat Rec, 248 (1997) 583-602.
5. Streicher, J., Donat, M. A., Strauss, B., Sporle, R., Schughart, K. and Muller, G. B., Computer-based three-dimensional visualization of developmental gene expression, Nat Genet, 25 (2000) 147-152.
6. Anderle, P., Duval, M., Draghici, S., et al. (2003) Gene expression databases and data mining. Biotechniques suppl, 36-44.
7. Nissanov J., and McEachron D. L. (1991) Advances in Image Processing for autoradiography. J. Chem. Neuroanot. 4, 329-342.
8. Nissanov J., Gertrand L., and Tretiak O. (2001) Cryosectioning distortion reduction using tape support. Microsc. Res. Tech. 53, 239-240.
9. William, B., Jonathan, N., (2003) A guide to building image Centric Databases, Neuroinformatics, 359-78
10. Gustafson C., Tretiak O., et al. (2004) Design and implementation of software for assembly and browsing of 3D brain atlases. Comput Methods Programs Biomed., in press.
11. Franklin, K. B. J. and Paxinos, G. (1998) The mouse brain in stereotaxic coordinates, 2nd ed., Academic Press, San Diego.
12. Toga, A. W., Santori, E. M., Hazani, R., and Ambach, K. (1995) A 3D digital map of rat brain. Brain Res. Bull. 38, 77-85.
13. Davidson. D., Bard, J., et al. (1997) The mouse atlas and graphical gene expression database. Seminars Cell Dev. Biol. 8, 509-517.

Background References

U.S. Patent Publication 2004/0199544

U.S. Patent Publication 2004/0119759

While a number of embodiments of the present invention have been shown and described herein in the present context, such embodiments are provided by way of example only, and not of limitation. Numerous variations, changes and substitutions will occur to those of skilled in the art without departing from the invention herein. For example, the present invention need not be limited to best mode disclosed herein, since other applications can equally benefit from the teachings of the present invention. Accordingly, it is intended that the invention be limited only by the spirit and scope of the appended claims in accordance with relevant law as to their interpretation.

What is claimed is:

1. A method of providing to remote users a quantitative analysis of image data comprising:
providing an image database that is accessible remotely by a remote user, wherein said image database comprises a plurality of non-compressed images of treated tissue sections from an anatomical location;
presenting to said remote user an option of selecting an image or images from a selection of low-resolution images pertaining to a specific geometric perspective of said anatomical location;
displaying to said remote user a compressed image corresponding to a low-resolution image selected by said remote user;
presenting to said remote user the option of selecting a region of interest in said compressed image selected by said remote user;
calculating pixel value statistics of said region of interest; and
providing to said remote user said pixel value statistics.

2. (canceled)

3. (canceled)

4. The method of claim 1, wherein said treated tissue sections are treated via in-situ hybridization histochemistry.

5. The method of claim 1, wherein said plurality of non-compressed images comprises scanned autoradiographs and/or Nissl-stained treated tissue sections.

6. The method of claim 1, wherein said presenting to said remote user an option of selecting an image or images from a selection of low-resolution images pertaining to a specific geometric perspective of said anatomical location comprises construction of a 3D data set from 2D in-situ hybrization histochemistry data and presenting to the remote user a manipulatable 3D image.

7. The method of claim 1, wherein said anatomical region is a brain.

8. The method of claim 7, wherein said brain is a non-human mammal brain.

9. An interactive gene expression map viewing and processing system comprising:
a database comprising a plurality of non-compressed images of treated tissue sections;
a processor, and
a computer program product comprising
a computer readable first program module for causing said processor to display to a remote user a selection of low-resolution images of said plurality of non-compressed images;
a computer readable second program module for causing said processor to present to said remote user an option to select at least one of said selection of low-resolution images;
a computer readable third program module for causing said processor to display to said remote user a compressed image corresponding to a low-resolution image selected by said remote user;
a computer readable fourth program code module for causing said processor to present an option of selecting a region of interest of said compressed image selected by said remote user;
a computer readable fifth program code module for causing said processor to calculate pixel value statistics of said region of interest using a non-compressed image; and
a computer readable sixth program code module for causing said processor to provide to said remote user said pixel value statistics.

10. The system of claim 9, wherein said plurality of non-compressed images comprises a stack of TIFF images.

11. The system of claim 10 further comprising a computer readable seventh program code module for causing said processor to identify a TIFF image from said TIFF stack corresponding to a low-resolution image selected by said remote user.

12. The system of claim 9, wherein said compressed image is a JPEG image.

13. The system of claim 9 further comprising an eighth program code module for causing said processor to split a compressed image into tiles.

14. The system of claim 13 further comprising a ninth program code module for causing said processor to present an option to zoom into said region of interest.

15. The system of claim 14 further comprising a tenth program code module for causing said processor to download tiles corresponding to said region of interest at a selected zoom level.
